(19) United States
(12) Patent Application Publication
(10) Pub. No.: US 2011/0258369 A1
(43) Pub. Date: Oct. 20, 2011

(54) Data Writing Method and Data Storage Device

(75) Inventor: Wei-Yi Hsiao, Kaohsiung City (TW)

(73) Assignee: SILICON MOTION, INC., Jhubei City (TW)

(21) Appl. No.: 13/084,122

(22) Filed: Apr. 11, 2011

(30) Foreign Application Priority Data
Apr. 16, 2010 (TW) 99111928

(51) Int. Cl. G06F 12/02

(52) U.S. Cl. 711/103; 711/E12.008

(57) ABSTRACT

The invention provides a data writing method for a memory. In one embodiment, the memory comprises a data area and a spare area, the data area comprises a plurality of data blocks storing data, and the spare area comprises a plurality of spare blocks having no data stored therein. First, a write command for writing a write data to a first data block of the flash memory is received from a host. A first spare block with the earliest erase time index is then selected from the spare area. Whether an erase count of the first spare block is less than a first threshold is then determined When the erase count of the first spare block is less than the first threshold, the write data is written to the first spare block. Data is then erased from the first data block to convert the first data block to a spare block.

### CROSS REFERENCE TO RELATED APPLICATIONS

This Application claims priority of Taiwan Patent Application No. 99111928, filed on Apr. 16, 2010, the entirety of which is incorporated by reference herein.

### BACKGROUND OF THE INVENTION

1. Field of the Invention

The invention relates to memories, and more particularly to flash memories.

2. Description of the Related Art

A flash memory comprises a plurality of blocks. Each block comprises a plurality of pages for data storage. Each block is also mapped to a unique address. When a host wants to access data stored in the flash memory, the host sends an access command to a controller of the flash memory, wherein the access command comprises an address of the block storing the data to be accessed. The controller then accesses data from the flash memory according to the address. For example, when the flash memory receives a write command from the controller, the flash memory writes data to the block corresponding to the address. When the flash memory receives a read command from the controller, the flash memory reads data from the block corresponding to the address and sends the read data back to the controller.

After data is written to all pages of a block of a flash memory, other data cannot be written to the block again. A plurality of blocks of a flash memory is therefore divided into data blocks of a data area and spare blocks of a spare area. Data blocks of the data area have stored data, and spare blocks of the spare area have no stored data. When the host wants to write data into a write address corresponding to a data block of the data area, because update data cannot be written to the data block again, the controller obtains a spare block from the spare area, changes the address of the spare block to the write address, and then writes the update data to the spare block. Because the data block originally mapped to the write address is useless, the controller erases data from the data block to convert the data block to a spare block.

Ordinarily, when a controller selects a spare block from the spare area, a first-in first-out (FIFO) method is used to select the spare block. In other words, the controller selects a spare block with the earliest erase time index in comparison with those of other spare blocks from the spare area. Referring to FIG. 2, a flowchart of a conventional data writing method 200 is shown. First, the controller receives a write command from a host (step 202). Assume that the write command requests the controller to write a write data to a first data block of the flash memory. Because the first data block has data stored therein, the controller cannot write the write data to the first data block. The controller therefore must obtain a target spare block for storing the write data in place of the first data block from the spare area of the flash memory. According to the first-in first-out method, the controller selects a first spare block with the earliest erase time index from the spare blocks of the spare area of the flash memory (step 204). The controller then takes the first spare block as the target spare block to hold the write data (step 206), and then controls the flash memory to write the write data to the target spare block (step 208). The target spare block therefore becomes a data block holding the write data in place of the first data block. The first data block holds old-version data and is useless. The controller therefore erases the old-version data from the first data block to convert the first data block to a spare block (step 210).

Referring to FIGS. 1A-1C, schematic diagrams of an embodiment of a conventional data writing method are shown. As shown in FIG. 1A, a data area 110 comprises data blocks 111, 112, 11K, 11P, 11Y, and 11Z which respectively have erase counts of 3, 5, 15, 6, 17, and 10. The spare area 120 comprises spare blocks 121, 122, 123, 124, and 12X which respectively have erase counts of 7, 11, 30, 9, and 12. Assume that a controller receives a write command for writing update data to the data block 11K of the data area 110. Because the update data cannot be written to the data block 11K which has data stored therein, the controller selects a spare block 121 with the earliest erase time index from the spare area to hold the update data in place of the data block 11K. After the spare block 121 stores the update data, the spare block 121 is moved to the data area 110, as shown in FIG. 1B. Data is then erased from the data block 11K, wherein the erase count of the data block 11K is increased from 15 to 16, and the data block 11K having no data stored therein is then moved to the spare area 120, as shown in FIG. 1B. Assume that the controller further receives a write command for writing second update data to the data block 11P of the data area 110. Because the second update data cannot be written to the data block 11P which has data stored therein, the controller selects a spare block 122 with the earliest erase time index from the spare area 120 to hold the second update data in place of the data block 11P. After the spare block 122 stores the second update data, the spare block 122 is moved to the data area 110, as shown in FIG. 1C. Data is then erased from the data block 11P, wherein the erase count of the data block 11P is increased from 6 to 7, and the data block 11P having no data stored therein is then moved to the spare area 120, as shown in FIG. 1C.

The conventional data writing method 200 shown in FIG. 2, however, has deficiency. Because the controller selects the target spare block for holding update data from the spare area according to only the first-in first-out method (step 204), the controller may obtain a target spare block with a high erase count. When the target spare block with a high erase count is used to store update data, the erase count of the target spare block is rapidly increased, inducing the risk of over-wearing the target spare block. Referring to FIGS. 3A and 3B, schematic diagrams of an embodiment of over-wearing of blocks according to a conventional data writing method are shown. In FIG. 3A, assume that the controller receives a writing command for writing update data to a data block 111 of a data area 110. Because the update data cannot be written to the data block 111 which has data stored therein, the controller selects a spare block 123 with the earliest erase time index from the spare area 120 to hold the update data in place of the data block 111. After the spare block 123 stores the update data, the spare block 123 is moved to the data area 110, as shown in FIG. 3B. Data is then erased from the data block 111, wherein the erase count of the data block 111 is increased from 3 to 4, and the data block 111 having no data stored therein is then moved to the spare area 120, as shown in FIG. 3B. The block 123 with a high erase count of 30 is still used to store update data. When data is erased from the block 123 again, the erase count of the block 123 is further increased to 31, increasing a risk of identifying the block 123 as an over-wear block. To solve the aforementioned problem, a new data writing method is required.

### BRIEF SUMMARY OF THE INVENTION

The invention provides a data writing method for a memory. In one embodiment, the memory comprises a data area and a spare area, the data area comprises a plurality of data blocks storing data, and the spare area comprises a plurality of spare blocks having no data stored therein. First, a write command for writing a write data to a first data block of the flash memory is received from a host. A first spare block with the earliest erase time index is then selected from the spare area. Whether an erase count of the first spare block is less than a first threshold is then determined. When the erase count of the first spare block is less than the first threshold, the write data is written to the first spare block. Data is then erased from the first data block to convert the first data block to a spare block.

The invention further comprises a data storage device. In one embodiment, the data storage device comprises a memory and a controller. The memory comprises a data area and a spare area, wherein the data area comprises a plurality of data blocks storing data, and the spare area comprises a plurality of spare blocks having no data stored therein. The controller receives a write command for writing a write data to a first data block of the flash memory from a host, selects a first spare block with the earliest erase time index from the spare area, determines whether an erase count of the first spare block is less than a first threshold, and when the erase count of the first spare block is less than the first threshold, writes the write data to the first spare block, and erases data from the first data block to convert the first data block to a spare block.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A˜1C are schematic diagrams of an embodiment of a conventional data writing method;

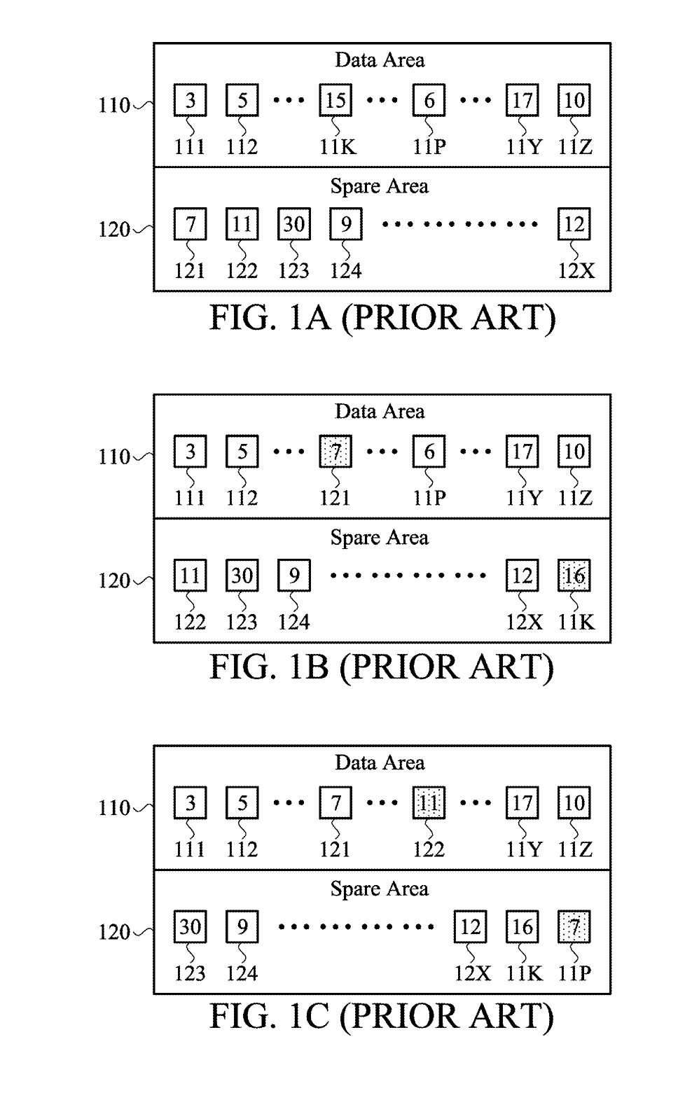

FIG. 2 is a flowchart of a conventional data writing method;

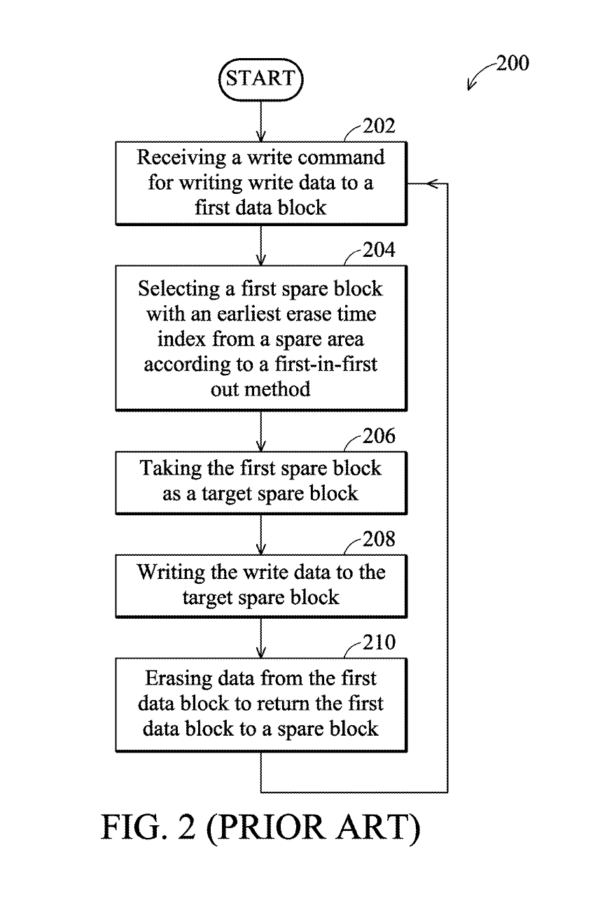

FIGS. 3A and 3B are schematic diagrams of an embodiment of over-wearing of blocks according to a conventional data writing method;

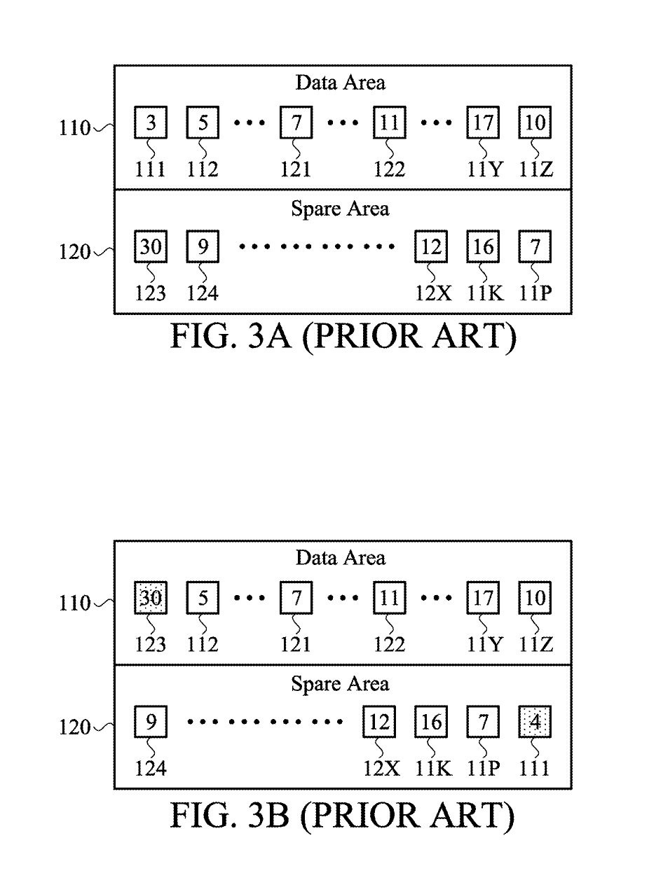

FIG. 4 is a block diagram of a data storage device according to the invention;

FIG. 5 is a flowchart of a data writing method according to the invention;

FIGS. 6A˜6C are schematic diagrams of an embodiment of data writing of the flash memory according to the invention; and

FIGS. 7A˜7C are schematic diagrams of an embodiment of a wear-leveling process of the flash memory according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

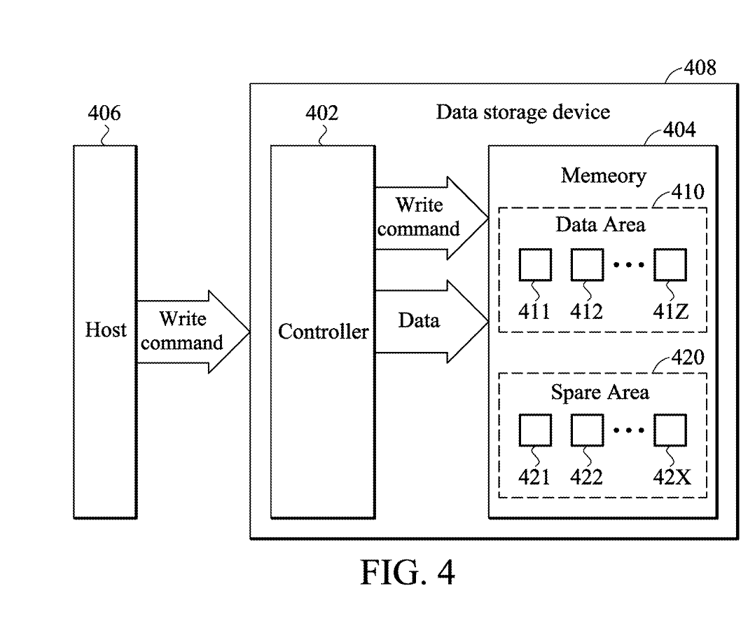

Referring to FIG. 4, a block diagram of a data storage device 408 according to the invention is shown. The data storage device 408 comprises a controller 402 and a memory 404. In one embodiment, the memory 404 is a flash memory. The memory 404 comprises a plurality of blocks for data storage. The blocks of the memory 404 are divided into two groups. A data area 410 contains data blocks 411, 412, . . . , 41Z which have stored data. A spare area 420 contains spare blocks 421, 422, . . . , 42X which have no stored data. The controller 402 receives access commands from a host 406, and accesses data stored in the memory 404 according to the access commands.

When the controller 402 receives a write command from the host 406, the controller 402 searches the memory 404 for a block corresponding to the address comprised by the write command. If the block corresponding to the address is a data block of the data area 410, because the data block has data stored therein, the controller 402 cannot write update data to the data block. The controller 402 then obtains a target spare block from the spare area 420 for storing the update data in place of the data block. When the controller selects a spare block as the target spare block, the controller checks whether the erase count of the spare block is greater than a first threshold, wherein the erase count indicates the frequency at which data has been erased from the spare block.

If the erase count of the selected spare block is lower than the first threshold, the selected spare block is determined to be the target spare block to hold the update data in place of the data block. If the erase count of the selected spare block is greater than the first threshold, the controller 402 must select another spare block with an erase count less than the first threshold from the spare area 420 to be the target spare block. Thus, the controller 402 always obtains a target spare block with an erase count less than the first threshold to hold the update data. Spare blocks with high erase counts therefore are not chosen as the target spare block to be written with update data, such that the erase counts of the spare blocks are therefore not further increased, and no over-wear blocks are therefore generated. The usable life-span of the blocks of the flash memory 404 is therefore extended, and the performance of the data storage device 408 is therefore improved.

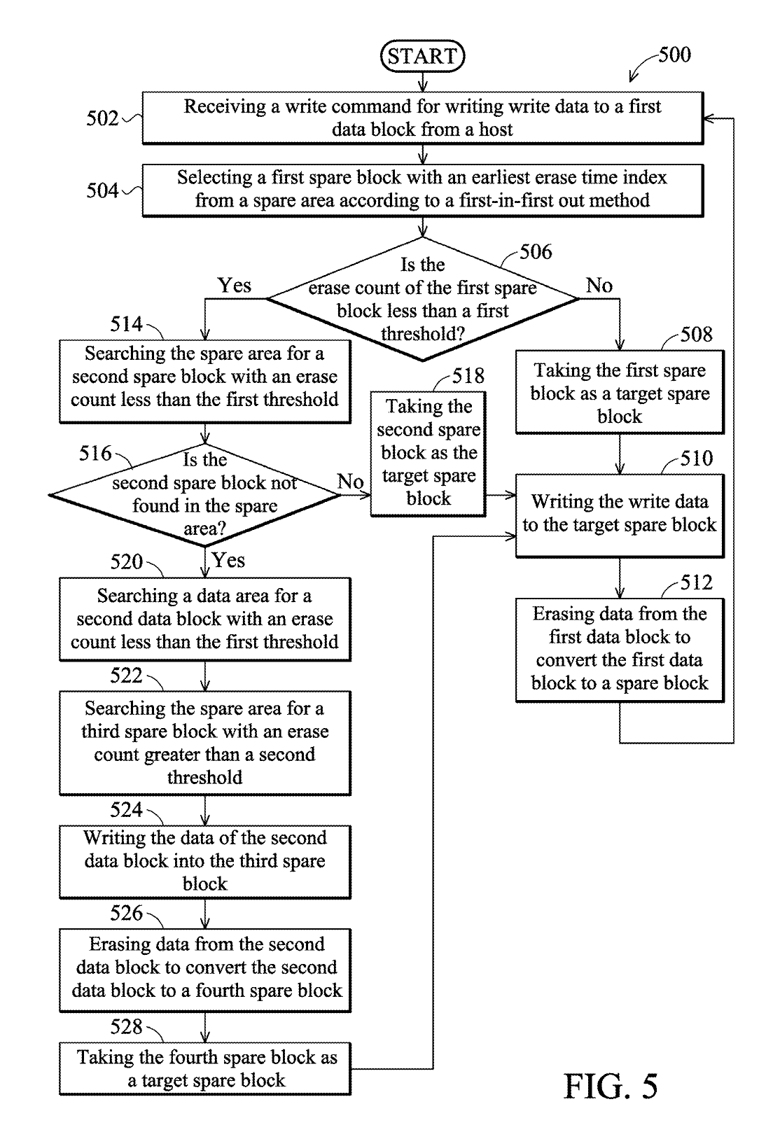

Referring to FIG. 5, a flowchart of a data writing method 500 according to the invention is shown. First, the controller 492 receives a write command from the host 406 (step 502). Assume that the write command requests the controller 402 to write a write data to a write address which is mapped to a first data block of the data area 410 of the memory 404. Because the first data block has data stored therein, the controller 402 therefore cannot write the write data to the first data block. The controller 402 therefore obtains a target spare block from the spare area 420 to hold the write data in place of the first data block. First, the controller 402 selects a first spare block with the earliest erase time index in comparison with other spare blocks from the spare area 420 according to the first-in first-out method (step 504). The controller 402 then compares the erase count of the first spare block with a first threshold (step 506). If the erase count of the first spare block is less than the first threshold, the controller 402 determines the first spare block to be the target spare block for holding the write data in place of the first data block (step 508). The controller 402 then writes the write data to the target spare block (step 510), and sets the logical address of the first spare block to be the write address. The first data block storing old-version data is therefore useless and has been replaced by the first spare block. The controller 402 then erases data from the first data block to convert the first data block to a spare block (step 512).

When the controller 402 compares the erase count of the first spare block with the first threshold (step 506), if the erase count of the first spare block is greater than the first threshold, the first spare block is not suitable for being the target spare block. The controller 402 therefore must select a new spare block from the spare area 420 to be the target spare block. The controller 402 therefore searches the spare area 420 for a second spare block with an erase count less than the first threshold (step 514). If the controller 402 successfully finds the second spare block from the spare blocks of the spare area 420 (step 516), the controller 402 determines the second spare block to be the target spare block for holding the write data in place of the first data block (step 518). The controller 402 then writes the write data to the target spare block (step 510), and sets the logical address of the first spare block to be the write address. The first data block storing old-version data is therefore useless and has been replaced by the first spare block. The controller 402 then erases data from the first data block to convert the first data block to a spare block (step 512).

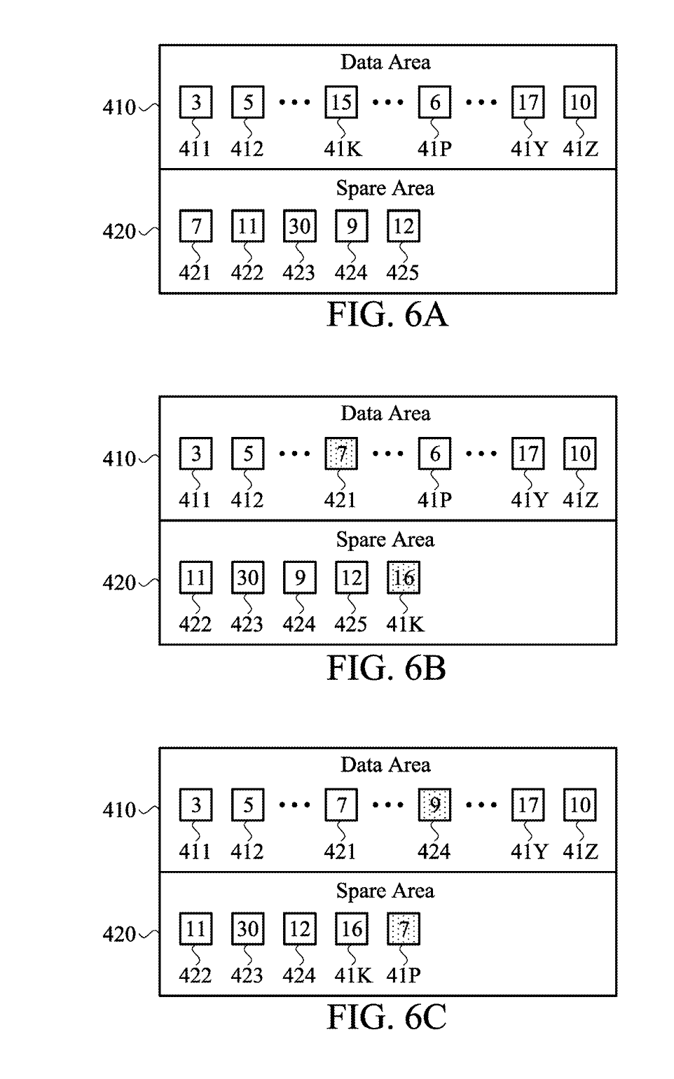

Referring to FIGS. 6A˜FIG. 6C, schematic diagrams of an embodiment of data writing of the flash memory 404 according to the invention are shown. As shown in FIG. 6A, a data area 410 comprises data blocks 411, 412, 41K, 41P, 41Y, and 41Z which respectively have erase counts of 3, 5, 15, 6, 17, and 10. The spare area 420 comprises spare blocks 421, 422, 423, 424, and 425 which respectively have erase counts of 7, 11, 30, 9, and 12. Assume that the controller 402 receives a write command for writing update data to the data block 41K of the data area 410. Because the update data cannot be written to the data block 41K which has data stored therein, the controller 402 selects a spare block 421 with the earliest erase time index from the spare area 420 according to the method 500 to hold the update data in place of the data block 41K. Assume that the first threshold is 10. Because the selected spare block 421 has an erase count 7 less than the first threshold 10, the controller 402 determines the selected spare block 421 to be the target spare block. The update data is then written to the target spare block 421. After the spare block 421 stores the update data, the spare block 421 is moved to the data area 410, as shown in FIG. 6B. Data is then erased from the data block 41K, wherein the erase count of the data block 41K is increased from 15 to 16, and the data block 41K having no data stored therein is then moved to the spare area 420, as shown in FIG. 6B.

Assume that the controller 402 further receives a write command for writing second update data to the data block 41P of the data area 410. Because the second update data cannot be written to the data block 41P which has data stored therein, the controller 402 selects a spare block 422 with the earliest erase time index from the spare area 420 to hold the second update data in place of the data block 41P. Because the selected spare block 422 has an erase count 11 greater than the first threshold 10, the selected spare block 422 is not qualified to be the target spare block. The controller 402 therefore must select another spare block as the target spare block. A next spare block 423 in the spare area 420 also has an erase count 30 greater than the first threshold 10 and is not qualified to be the target spare block. A third spare block 424 in the spare area 420 has an erase count 9 less than the first threshold 10 and is therefore qualified to be the target spare block. The controller 402 therefore determines the third spare block 424 to be the target spare block, and writes the second update data to the target spare block 424. After the spare block 424 stores the second update data, the spare block 424 is moved to the data area 410, as shown in FIG. 6C. Data is then erased from the data block 41P, wherein the erase count of the data block 41P is increased from 6 to 7, and the data block 41P having no data stored therein is then moved to the spare area 420, as shown in FIG. 6C.

The steps 520˜528 of the data writing method 500 shown in FIG. 5 are referred to as a wear-leveling process. At step 520, the controller 402 searches the spare area 420 for a second spare block with an erase count less than the first threshold. If the erase counts of all spare blocks of the spare area 420 are greater than the first threshold, the controller 402 cannot find a second spare block with an erase count less than the first threshold in the spare area 420 (step 516). The controller 420 then performs a wear-leveling process to convert a data block with an erase count less than the first threshold into a spare block as the target spare block for holding the update data. First, the controller 402 searches the data area 410 for a second data block with an erase count less than the first threshold (step 520). The controller 402 then searches the spare area 420 for a third spare block with an erase count greater than a second threshold (step 522), wherein the second threshold is greater than the first threshold. In one embodiment, the controller 402 searches the spare area 420 for a spare block with the largest erase count as the third spare block.

The controller 402 then writes the data stored in the second data block to the third spare block (step 524), and changes the logic address of the third spare block to that of the second data block. The second data block is now replaced by the third spare block, and the controller 402 then erases data from the second data block to convert the second data block to a fourth spare block (step 526). Because the fourth spare block converted from the second data block has an erase count less than the first threshold, the fourth spare block is qualified to be a target spare block. The controller 420 then determines the fourth spare block to be the target spare block (step 528), writes the write data to the target spare block (step 510), and sets the logic address of the target spare block to be that of the first data block. The first data block storing old-version data is now replaced by the fourth spare block, and the controller 420 therefore erases data from the first data block to convert the first data block to a spare block (step 512).

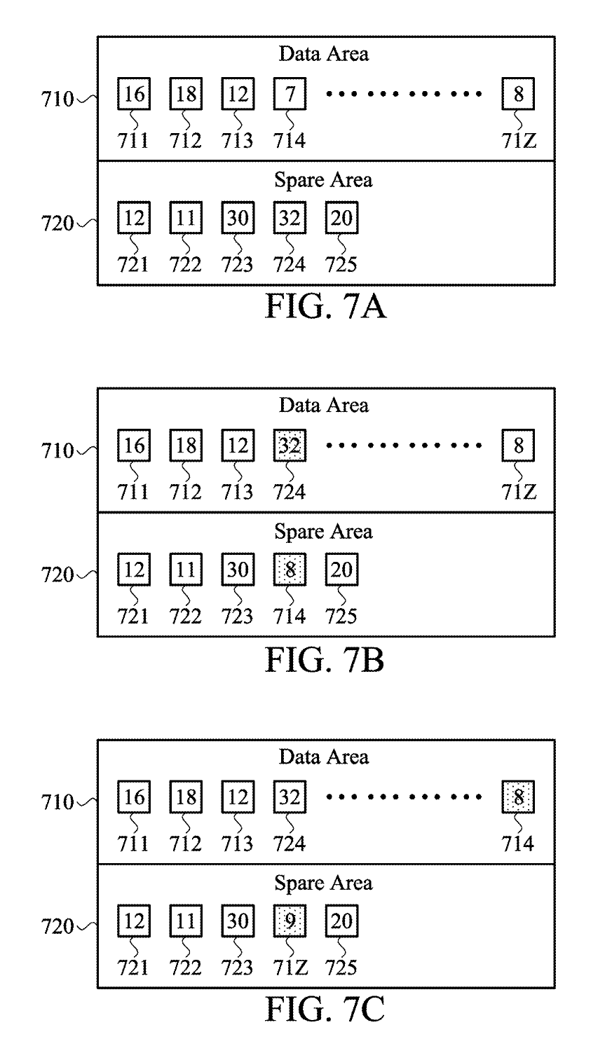

Referring to FIGS. 7A-7C are schematic diagrams of an embodiment of a wear-leveling process of the flash memory according to the invention. As shown in FIG. 7A, a data area 710 comprises data blocks 711, 712, 713, 714, and 71Z which respectively have erase counts of 16, 18, 12, 7, and 8. The spare area 720 comprises spare blocks 721, 722, 723, 724, and 725 which respectively have erase counts of 12, 11, 30, 32, and 20. Assume that a controller 402 receives a write command for writing update data to the data block 71Z of the data area 710. Because the update data cannot be written to the data block 71Z which has data stored therein, the controller 402 selects a target spare block according to the method 500 from the spare area 720 to hold the update data in place of the data block 71Z. Assume the first threshold is 10 and the second threshold is 30. Because the erase counts of all spare blocks 721-725 of the spare area 720 are greater than the first threshold 10, the spare blocks 721-725 are all not qualified to be the target spare block. The controller 402 then performs a wear-leveling process according to the steps 520-528 of the method 500 shown in FIG. 5. The controller 402 first searches the data area 710 to obtain a data block 714 with an erase count 7 less than the first threshold 10, and searches the spare area 720 to obtain a spare block 724 with an erase count 32 larger than the second threshold 30. The controller 402 then writes the data of the data block 714 to the spare block 724, and moves the spare block 724 to the data area 710. The controller 402 also erases data from the data block 714, and moves the data block 714 to the spare area 720. The controller 402 therefore successfully replaces the spare block 724 with the data block 714, as shown in FIG. 7B.

The spare area 720 now comprises a spare block 714 with an erase count less than the first threshold 10. Because the spare block 714 is qualified to be the target spare block, the controller 402 selects the spare block 714 to be the target spare block for storing the update data in place of the data block 71Z. The update data is then written to the target spare block 714. After the target spare block 714 stores the update data, the target spare block is moved to the data area 710, as shown in FIG. 7C. The data block 71Z storing old-version data is now useless. The controller 402 then erases data from the data block 71Z, wherein the erase count of the data block 71Z is increased to 9, and the data block 71Z having no data stored therein is moved to the spare area 720, as shown in FIG. 7C.

Finally, when the controller 402 performs the wear-leveling process at the step 522, the erase counts of all data blocks in the data area 410 may be greater than the first threshold, thus, the controller 402 finds no data blocks with an erase count less than the first threshold from the data area 410. The controller 402 then subtracts a value from all erase counts of the data blocks of the data area 410, thereby decreasing the erase counts of the data blocks of the data area 410. In one embodiment, the value is equal to half of the first threshold. When the erase counts of the data blocks of the data area 410 are decreased, the controller 402 can then successfully search the data area 410 for a second data block with an erase count less than the first threshold.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data writing method for a memory, wherein the memory comprises a data area and a spare area, the data area comprises a plurality of data blocks storing data, and the spare area comprises a plurality of spare blocks having no data stored therein, comprising:
receiving a write command for writing a write data to a first data block of the flash memory from a host;
selecting a first spare block with the earliest erase time index in comparison with those of other spare blocks from the spare area;
determining whether an erase count of the first spare block is less than a first threshold;
when the erase count of the first spare block is less than the first threshold, writing the write data to the first spare block; and
erasing data from the first data block to convert the first data block to a spare block.

2. The data writing method as claimed in claim 1, wherein the data writing method further comprises:
when the erase count of the first spare block is greater than the first threshold, searching for a second spare block with an erase count less then the first threshold in the spare area;
writing the write data to the second spare block; and
erasing data from the first data block to convert the first data block to a spare block.

3. The data writing method as claimed in claim 2, wherein the data writing method further comprises:
when the second spare block is not found in the spare area, performing a wear-leveling process to convert a second data block of the data area to a third spare area;
writing the write data to the third spare block; and
erasing data from the first data block to convert the first data block to a spare block;
wherein the third spare block has an erase count less than the first threshold.

4. The data writing method as claimed in claim 3, wherein the wear-leveling process comprises:
searching the data area for the second data block with an erase count less than the first threshold;
searching the spare area for a fourth spare block with an erase count greater than a second threshold;
writing the data of the second data block to the fourth spare block; and
erasing data from the second data block to convert the second data block to the third spare block;
wherein the second threshold is greater than the first threshold.

5. The data writing method as claimed in claim 3, wherein the wear-leveling process further comprises:
searching the data area for the second data block with an erase count less than the first threshold;
searching the spare area for a fourth spare block with an erase count which is the highest in comparison with those of other spare blocks in the spare area;
writing the data of the second data block to the fourth spare block; and
erasing data from the second data block to convert the second data block to the third spare block.

6. The data writing method as claimed in claim 4, wherein obtaining of the
when the data area does not comprises a data block with an erase count less than the first threshold, subtracting a predetermined count from the erase counts of all data blocks of the data area; and
searching the data area for the second data block with an erase count less than the first threshold.

7. The data writing method as claimed in claim 6, wherein the predetermined count is equal to the first threshold.

8. A data storage device, comprising:
a memory, comprising a data area and a spare area, wherein the data area comprises a plurality of data blocks storing data, and the spare area comprises a plurality of spare blocks having no data stored therein; and
a controller, receiving a write command for writing a write data to a first data block of the flash memory from a host, selecting a first spare block with the earliest erase time index from the spare area, determining whether an erase count of the first spare block is less than a first threshold, and when the erase count of the first spare block is less than the first threshold, writing the write data to the first spare block, and erasing data from the first data block to convert the first data block to a spare block.

9. The data storage device as claimed in claim 8, wherein when the erase count of the first spare block is greater than the first threshold, the controller searches the spare area for a second spare block with an erase count less then the first threshold, writes the write data to the second spare block, and erases data from the first data block to convert the first data block to a spare block.

10. The data storage device as claimed in claim 9, wherein when the second spare block is not found in the spare area, the controller performs a wear-leveling process to convert a second data block of the data area to a third spare area, writes the write data to the third spare block, and erases data from the first data block to convert the first data block to a spare block, wherein the third spare block has an erase count less than the first threshold.

11. The data storage device as claimed in claim 10, wherein the controller searches the data area for the second data block with an erase count less than the first threshold, searches the spare area for a fourth spare block with an erase count greater than a second threshold, writes the data of the second data block to the fourth spare block, and erases data from the second data block to convert the second data block to the third spare block, thereby performing the wear-leveling process, wherein the second threshold is greater than the first threshold.

12. The data storage device as claimed in claim 10, wherein the controller searches the data area for the second data block with an erase count less than the first threshold, searches the spare area for a fourth spare block with an erase count which is the highest in comparison with those of other spare blocks in the spare area, writes the data of the second data block to the fourth spare block, and erases data from the second data block to convert the second data block to the third spare block, thereby performing the wear-leveling process.

13. The data storage device as claimed in claim 11, wherein when the data area does not comprises a data block with an erase count less than the first threshold, the controller subtracts a predetermined count from the erase counts of all data blocks of the data area, and searches the data area for the second data block with an erase count less than the first threshold.
